(19) United States
(12) Patent Application Publication
(10) Pub. No.: US 2009/0146358 A1
(43) Pub. Date: Jun. 11, 2009

(54) Clamp

(76) Inventor: Ching-Jhen YANG, Taichung City (TW)

Correspondence Address: Dr. BANGER SHIA;Int''l Patent Office of Bang Shia, 102 Lindencrest Ct, Sugar Land, TX, 77479-5201, US

(21) Appl. No.: 12/256,842

(22) Filed: Oct. 23, 2008

(30) Foreign Application Priority Data
Dec. 11, 2007 (TW) 096220995

(51) Int. Cl. B25B 5/06

(52) U.S. Cl. 269/254 R

(57) ABSTRACT

A clamp includes a guiding rod, a stationary jaw secured to the guiding rod, a movable jaw movably provided on the guiding rod and a fastening unit. The movable jaw is formed with a ring and two helical grooves in an internal side of the ring. The fastening unit includes a knob, an axle and a latch. The axle is connected to the knob and inserted through the ring for abutment against the guiding rod. The latch is connected to the axle and formed with two ends for sliding in the helical grooves.

### FIELD OF INVENTION

The present invention relates to an efficient and precise clamp.

### BACKGROUND OF INVENTION

Disclosed in Taiwanese Patent M284485 is a clamp including a guiding rod, a stationary jaw secured to the guiding rod and a movable jaw supported on the rod. A fastener such as a threaded bolt is driven to the guiding rod through the movable jaw. The fastener can be rotated in a direction to a locking position to keep the movable jaw in position on the guiding rod. The fastener can be rotated in an opposite direction to a releasing position to allow the movement of the movable jaw on the guiding rod. It however requires several circles of the rotation of the fastener between the locking and releasing positions because the pitch of the fastener is small. This is inefficient. Moreover, it requires experience from a user to determine whether the locking position has been reached, i.e., the locking position is not precise.

Therefore, the present invention is intended to obviate or at least alleviate the problems encountered in prior art.

### SUMMARY OF INVENTION

It is an objective of the present invention to provide an efficient clamp.

It is another objective of the present invention to provide a precise clamp.

To achieve the foregoing objectives, the clamp includes a guiding rod, a stationary jaw secured to the guiding rod, a movable jaw provided on the guiding rod and a fastening unit. The movable jaw is formed with a ring and two helical grooves in an internal side of the ring. The fastening unit includes a knob, an axle and a latch. The axle is connected to the knob and inserted through the ring for abutment against the guiding rod. The latch is connected to the axle and formed with two ends for sliding in the helical grooves.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is an exploded view of a clamp according to the preferred embodiment of the present invention.

FIG. 2 is a side view of the clamp shown in FIG. 1.

FIG. 3 is a partial cross-sectional view of the clamp shown in FIG. 2.

### DETAILED DESCRIPTION OF PREFERRED EMBODIMENT

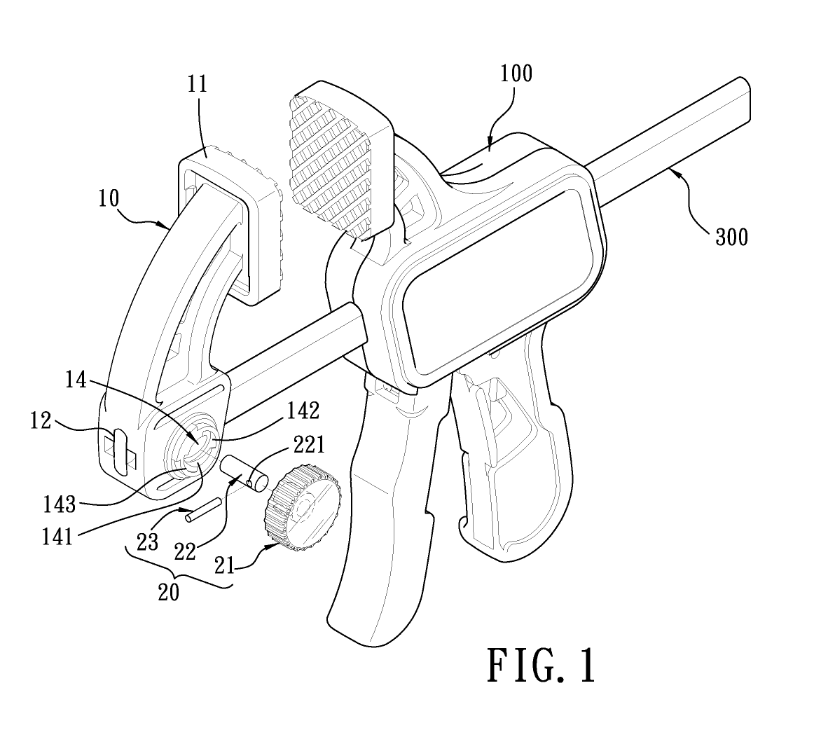

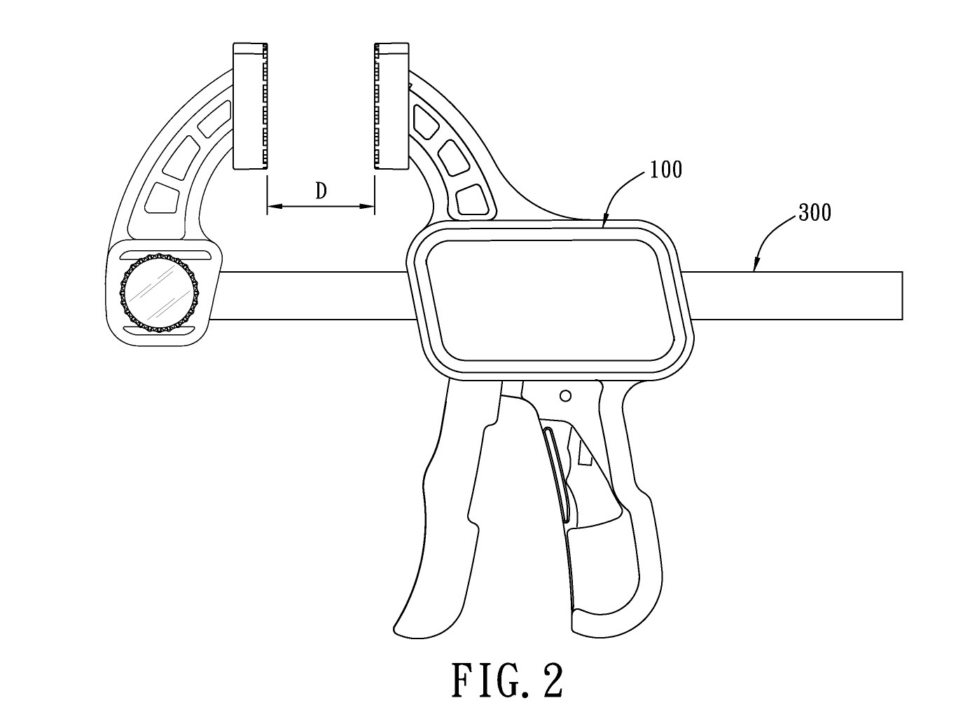

Referring to FIGS. 1 and 2, a clamp includes a guiding rod 300, a stationary jaw 100, a movable jaw 10 and a fastening unit 20 according to the preferred embodiment of the present invention. The stationary jaw 100 includes a first end formed with a rough surface and a second end formed on a pistol-shaped body. The rough surface of the stationary jaw 100 is used for contact with a work piece. The guiding rod 300 is inserted through and secured to the pistol-shaped body.

The movable jaw 10 includes a first end 11 formed with a rough surface and a second end 12 formed with a slot. The rough surface of the movable jaw 10 is used for contact with the work piece. The distance D between the rough surface of the movable jaw 10 and the rough surface of the stationary jaw 100 is adjustable. The guiding rod 30 is inserted through the slot of the movable jaw 10. A ring 14 is formed on the movable jaw 10 near the second end. An aperture 141 is defined in the ring 14. Two helical grooves 142 and 143 are defined in the wall of the aperture 141 so that the helical grooves 142 and 143 are in communication with the aperture 141. The helical groove 142 includes a first end 1421 and a second end 1422. The helical groove 143 includes a first end 1431 and a second end 1432.

The fastening unit 20 includes a knob 21, an axle 22 connected to the knob 21 and a latch 23 connected to the axle 22. The latch 23 includes an end for sliding in the helical groove 142 and another end for sliding in the helical groove 143.

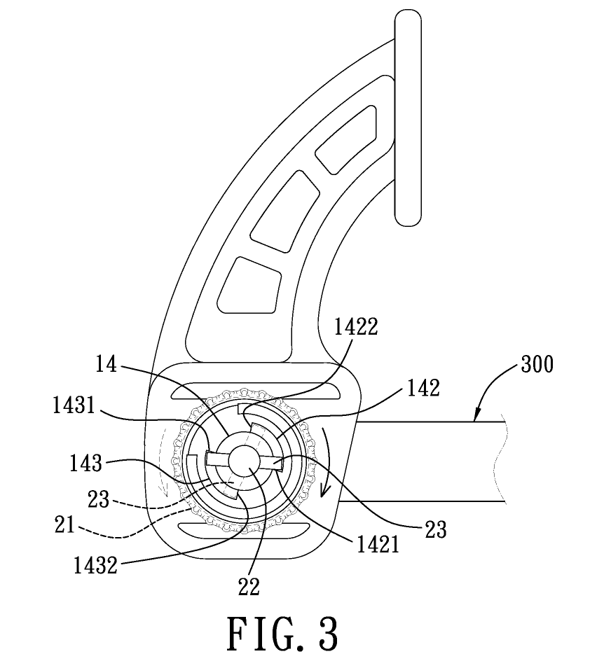

Referring to FIG. 3, the knob 21 can be rotated clockwise so that the ends of the latch 23 are located at the first ends 1421 and 1431 of the helical grooves 142 and 143. The axle 22 is abutted against the rod 300 so that the movable jaw 10 is kept in position on the rod 300. That is, the fastening unit 20 is in a locking position.

The knob 22 can be rotated counterclockwise so that the ends of the latch 23 are located at the second ends 1422 and 1432 of the helical grooves 142 and 143. The axle 22 is removed from the rod 300 so that the movable jaw 10 is movable on the rod 300. That is, the fastening unit 20 is in a releasing position.

It requires only one quarter of a circle of the rotation of the knob 21 between the locking and releasing positions, and the operation is efficient. Moreover, in the locking position, the ends of the latch 23 reach the first ends 1421 and 1431 of the helical grooves 142 and 143 so that the knob 21 cannot be rotated clockwise. In the releasing position, the ends of the latch 23 reach the second ends 1422 and 1432 of the helical grooves 142 and 143 so that the knob 21 cannot be rotated counterclockwise. Hence, the operation is precise.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clamp comprising:
a guiding rod;
a stationary jaw secured to the guiding rod;
a movable jaw provided on the guiding rod and formed with a ring and two helical grooves in an internal side of the ring; and
a fastening unit comprising:
a knob;
an axle connected to the knob and inserted through the ring for abutment against the guiding rod; and
a latch connected to the axle and formed with two ends for sliding in the helical grooves.

2. The clamp according to claim 1, wherein the grooves are helical.

3. The clamp according to claim 1, wherein each of the grooves comprises a first end for abutting a related one of the ends of the latch in a locking position and a second end for abutting the related end of the latch in a releasing position.
